(19) United States
(12) Patent Application Publication
(10) Pub. No.: US 2003/0149692 A1
(43) Pub. Date: Aug. 7, 2003

(54) Assessment methods and systems

(76) Inventor: Thomas Anderson Mitchell, Glasgow (GB)

Correspondence Address: Fleshner & Kim, PO Box 221200, Chantilly, VA, 20153-1200, US

(21) Appl. No.: 10/239,059

(22) PCT Filed: Mar. 20, 2001
(86) PCT No.: PCT/GB01/01206

(30) Foreign Application Priority Data
Mar. 20, 2000 (GB) 000672.5

(51) Int. Cl. G06F 17/30

(52) U.S. Cl. 707/4

(57) ABSTRACT

An information extraction system for the electronic assessment of free-form text against a standard for such text, in which semantic-syntactic templates prepared from the standard are compared with a semantically-syntactically tagged form of the free-form text, and an output assessment is derived in accordance with the result of this comparison.

The present invention relates to an information extraction system and methods used in the computer-based assessment of free-form text against a standard for such text.

Information extraction systems analyse free-form text and extract certain types of information which are pre-defined according to what type of information the user requires the system to find. Rather than try to understand the entire body of text in which the relevant information is contained, information extraction systems convert free-form text into a group of items of relevant information.

Information extraction systems generally involve language processing methods such as word recognition and sentence analysis. The development of an Information Extraction system for marking text answers provides certain unique challenges. The marking of the text answers must take account of the potential variations in the writing styles of people, which can feature such things as use of jargon, abbreviations, proper names, typographical errors and misspellings and note-style answers. Further problems are caused by limitations in Natural Language Processing technology. The current system provides a system and method which uses a method of pre- and post-parse processing free-form text which takes account of limitations in Natural Language Processing technology and common variations in writing, which would otherwise result in an answer being marked incorrectly.

In the prior art information extraction systems and other types of systems are known for the electronic scoring of text.

U.S. Pat. No. 6,115,683 refers to a system for automatically scoring essays, in which a parse tree file is created to represent the original essay. This parse tree file is then morphology-stripped and a concept extraction program applied to create a phrasal node file. This phrasal node file is then compared to predefined rules and a score for the essay generated. This system is not an information extraction system, as the entire essay is represented in parse tree format, i.e.—no information is extracted from the text. This prior system also does not provide for the pre- and post-parse processing of text. Thus, no account is taken of commonly made errors or of the limitations of Natural Language Processing, so the answers may be marked wrongly as a result.

U.S. Pat. No. 5,371,807 to Digital Equipment Corporation refers to the parsing of natural language text into a list of recognised key words. This list is used to deduce further facts, then a “numeric similarity score” is generated. However, rather than using this similarity score to determine if the initial text is correct or incorrect in comparison to the pre-defined keywords, they are used to determine which of a plurality of categories is most similar to the recognised keywords.

U.S. Pat. No. 6,076,088 refers to an information extraction system which enables users to query databases of documents. U.S. Pat. No. 6,052,693 also utilises an information extraction process in the assembly of large databases from text sources. These systems do not apply information extraction processes to the marking of free-form text as the current system does.

It is an object of at least one embodiment of the present invention to provide a system and method for the computer-based assessment of free-form text against a standard for such text, comprising means to prepare a semantic-syntactic templates from the standard, means to compare these templates with a semantically-syntactically tagged form of the free-form text, and means for deriving an output assessment in accordance with the result of the comparison.

It is a further object of at least one embodiment of the present invention to provide a system and method for the electronic assessment of free-form text which pre- and post-parse processes free-form text in order to take account of deficiencies in natural language processing parsers and errors and/or idiosyncrasies which are common in text answers.

Within this document, the statements of invention and claims, the term ‘lemmatisation’ refers to the reduction of a variant word to its root form. For example, past tense verbs are converted to present tense form—e.g,—“swept” to “sweep”.

Within this document, the statements of invention and claims, the terms “pre-parse processing” and “post-parse processing” refer to processes which can be incorporated into each other (e.g.—the pre-parse processing techniques may be incorporated into the post-parse process, and vice versa) or otherwise altered in order of execution.

According to the first aspect of the present invention there is provided an information extraction system for the computer-based assessment of free-form text against a standard for such text.

According to the second aspect of the present invention there is provided an information extraction system for the computer-based assessment of free-form text against a standard for such text, the system comprising means to prepare a semantic-syntactic template from the standard means to compare this template with a semantically-syntactically tagged form of the free-form text, and means for deriving an output assessment in accordance with the comparison.

Typically, the system uses natural language processing to pre-process each mark scheme answer to generate a template of semantic and syntactic information for that answer.

Preferably, the natural language processing parses the mark scheme answer into constituent parts such as nouns, verbs, adjectives, adverbs, modifiers and prepositions.

More preferably, data-representations of the constituent parts of each mark scheme answer are submitted to semantic analysis.

Optionally, the semantic analysis removes superfluous words from the syntactic structure of the mark scheme answer.

Once the superfluous words have been removed, the remaining words may be lemmatised.

Typically, the remaining words are annotated with semantic information, including information such as synonyms and mode of verbs (e.g. positive or negative).

Optionally, additional information relating to the structure of allowable pattern-matches is introduced to derive data representative of a template against which a range of syntactically and semantically equivalent phrases can be matched.

Optionally, the template data and test data are available to the human operator for testing and modifying the template derived for the mark scheme answers.

Typically, the mark scheme answer template also includes the identification code of the question.

Typically, the mark scheme answer template also includes the total number of marks available for each part of the answer.

Typically, the mark scheme answer template also includes the number of marks awarded per matched answer.

Preferably, the system applies natural language processing to the submitted student answer.

Typically, the natural language processing parses the student answer into constituent parts such as nouns, verbs, adjectives, adverbs, modifiers and prepositions.

The data representations of the constituent parts of each student answer may be submitted to semantic analysis.

The words in the student answer may be lemmatised, by which variant forms of words are reduced to their root word.

Typically, the words in the student answer are annotated with semantic information, including information such as mode of verbs, verb subject, etc (e.g. positive and negative).

The system may utilise data supplied from a lexical database.

Preferably, a comparison process is carried out between the key syntactic structure of the mark scheme answer's template (with semantic information tagged on) and the key syntactic structure of the student answer (with semantic information tagged on) to pattern-match these two structures.

This process may be carried out using data from a database of pattern-matching rules specifying how many mark-scheme answers are satisfied by a student answer submitted in an examination.

Preferably, a mark-allocation process is performed in accordance with the result of the comparison process.

More preferably, the mark-allocation process is also performed in accordance with data supplied from a database which specifies how many marks are to be awarded for each of the correctly-matched items of the submitted student answer.

Preferably, the output of the mark-allocation process provides a marking or grading of the submitted student answer.

More preferably, the output of the mark-allocation process provides feedback or information to the student regarding the standard of their submitted answer.

Optionally, the student can receive information on which mark scheme answer or answers he or she received credit for in their answer.

The student may receive information on alternate or improved ways in which they could have worded their answer to gain increased marks.

The processing of student answers to produce the output marking or grading may be performed in real time.

This processing may be performed by means of the Internet.

According to the third aspect of the present invention, there is provided a method of extracting information for the computer-based assessment of free-form text against a standard for such text, the method comprising the steps of:

Preparing a semantic syntactic template from the pre-defined standard for the free-form text;

Preparing a semantically syntactically tagged form of the submitted free-form text;

Comparing the standard template with the tagged submitted text;

Deriving an output assessment in accordance with the comparison.

Preferably, the pre-defined standard for the free-form text is parsed using natural language processing.

More preferably, the submitted free-form text is semantically and syntactically tagged using natural language processing.

Typically, this processing extracts the constituent parts of the mark scheme answers, for example (but not limited to):

Nouns;

Verbs;

Modifiers;

Prepositions;

Adjective;

Adverbs;

Any of the abovementioned word types.

Optionally, the extracted words are lemmatised to reduce variant forms of these words to their root form.

Typically, the extracted words are annotated with semantic information such as (but not limited to):

The word;

The word type;

The word's matching mode.

Optionally, extracted verbs are further annotated with semantic information such as (but not limited to):

The verb's mode;

The verb's subject;

The verb's subject type;

The verb's subject matching mode.

Preferably, the processed mark scheme template is compared with the semantically-syntactically tagged form of the submitted free-form text by trying each possible parse of the submitted answer against the associated mark scheme until each parse has been awarded all the available marks for this question, or until no more parses remain in the submitted answer.

Typically, the method utilises “synsets” in comparing the standard template with the tagged submitted text, which comprise a list of synonym words for each of the Tagged words in the mark scheme.

Preferably, a match is formed between template and submitted text when a word in each synset list for a template mark scheme answer is uniquely matched against a word in the submitted text, and all synset lists for the individual mark scheme answer are matched.

Optionally, a human operator tailors the template appropriately for the mark scheme answers.

This human operator may act in conjunction with data in a store related to semantic rules.

This human operator may act in conjunction with data in a store related to a corpus or body of test data.

According to the fourth aspect of the present invention, there is provided a system for the computer-based assessment of free-form text, characterised in that the text is processed to take account of common errors.

Optionally, the system is capable of processing text written by children to take account of errors which are common to children's writing.

Typically, these errors include errors of punctuation, grammar, spelling and semantics.

Preferably, the input text is pre-parse processed to increase its chances of being successfully parsed by natural language processing.

More preferably, the pre-parse processing comprises character level pre-parse processing and word level pre-parse processing.

Optionally, character level pre-parse processing involves processing each character of the submitted input string in turn, applying rules to facilitate the natural language processing of the text.

Optionally, word level pre-parse processing involves processing each word of the submitted input string in turn, spell checking each word, replacing words with more than a set number of characters and substituting recognised concatenations of words with expanded equivalents.

Optionally, common collocations of words are replaced with a single equivalent word or tag.

Preferably, the input text is post-parse processed to allow sentences which are clear in meaning but may not successfully parse during natural language processing to be successfully parsed and assessed.

Post-parse processing of input text may make allowances for sentences containing semantic or grammatical errors which may not match with the mark scheme.

According to the fifth aspect of the present invention, a custom spell checking algorithm is used to employ information about the context of misspelled words to improve spell checking.

Preferably, the algorithm employs commercially available spell checking software.

Optionally, the commercially available spell checking software gives preference to words which appear in the mark scheme when suggesting alternative words to misspelled words.

Optionally, the suggested alternative word put forward by the spell checking software is lemmatised and put forward as a suggestion, giving preference to words which appear in the mark scheme.

According to the sixth aspect of the present invention there is provided a computer program comprising program instructions for causing a computer to perform the process of extracting information for the computer-based assessment of free-form text against a standard for such text, the method comprising the steps of:

Preparing a semantic syntactic template from the pre-defined standard for the free-form text;

Preparing a semantically syntactically tagged form of the submitted free-form text;

Comparing the standard template with the tagged submitted text;

Deriving an output assessment in accordance with the comparison.

According to the seventh aspect of the present invention there is provided a computer program comprising program instructions which, when loaded into a computer, constitute the processing means of an information extraction system for the computer-based assessment of free-form text against a standard for such text, the system comprising means to prepare a semantic-syntactic template from the standard means to compare this template with a semantically-syntactically tagged form of the free-form text, and means for deriving an output assessment in accordance with the comparison.

According to the eighth aspect of the present invention there is provided a computer program comprising program instructions which, when loaded into a computer, constitute the processing means of an information extraction system for the computer-based assessment of free-form text against a standard for such text, the system comprising means to prepare a semantic-syntactic template from the standard means to compare this template with a semantically-syntactically tagged form of the free-form text, and means for deriving an output assessment in accordance with the comparison.

In order to provide a better understanding of the present invention, an example will now be described by way of example only with reference to the accompanying figures in which:

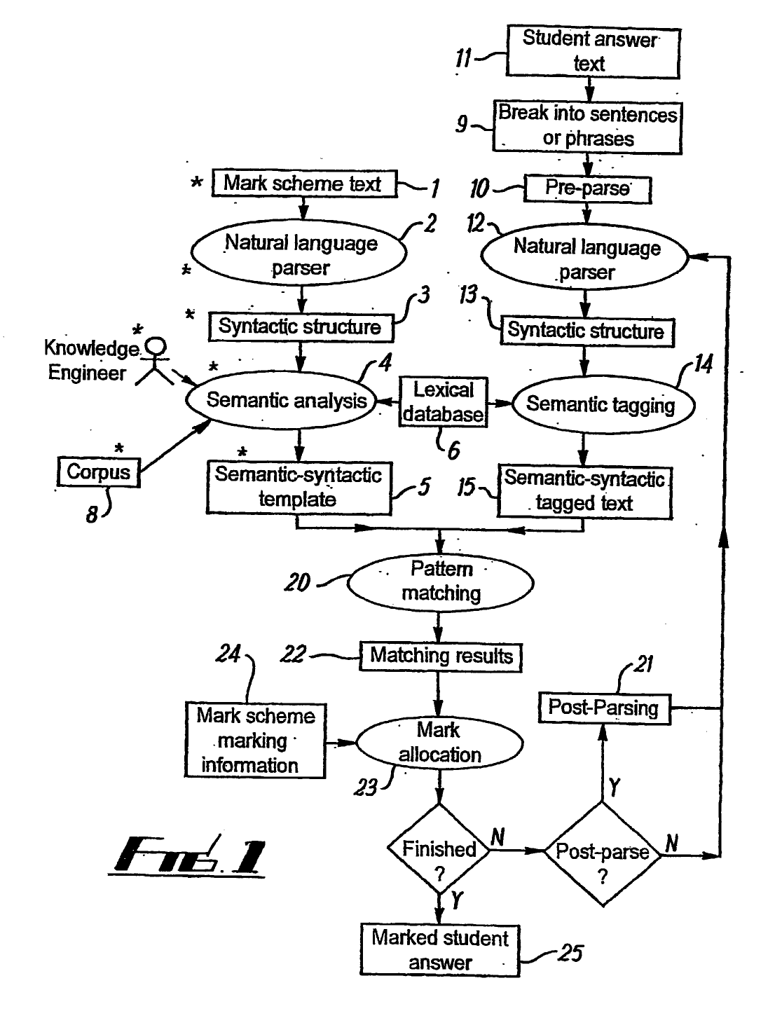

FIG. 1 illustrates the process of assessing free-form text against a text marking scheme;

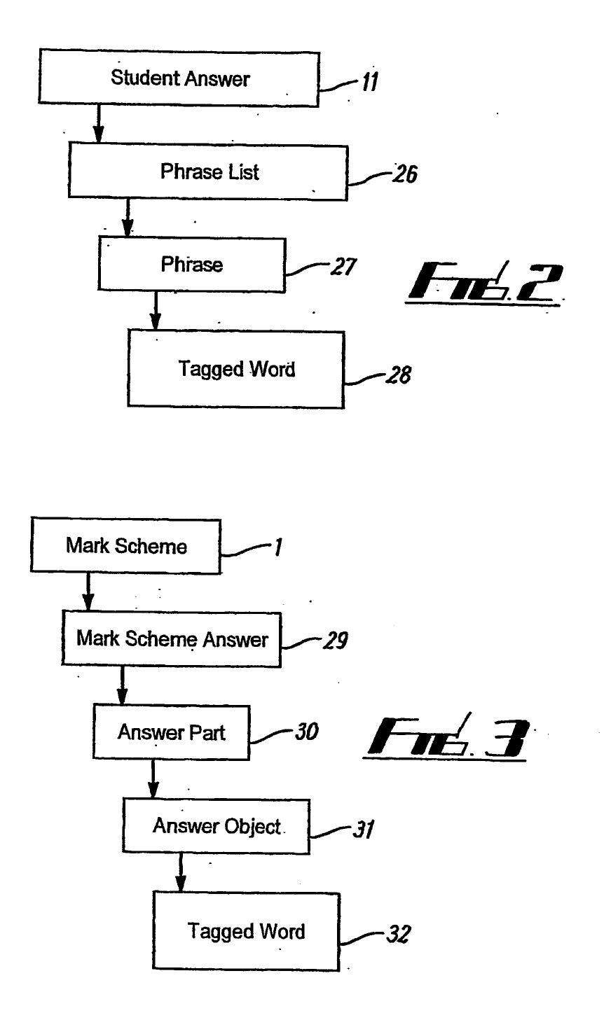

FIG. 2 illustrates the hierarchy of data structures extracted from the free-form text answer submitted by the student;

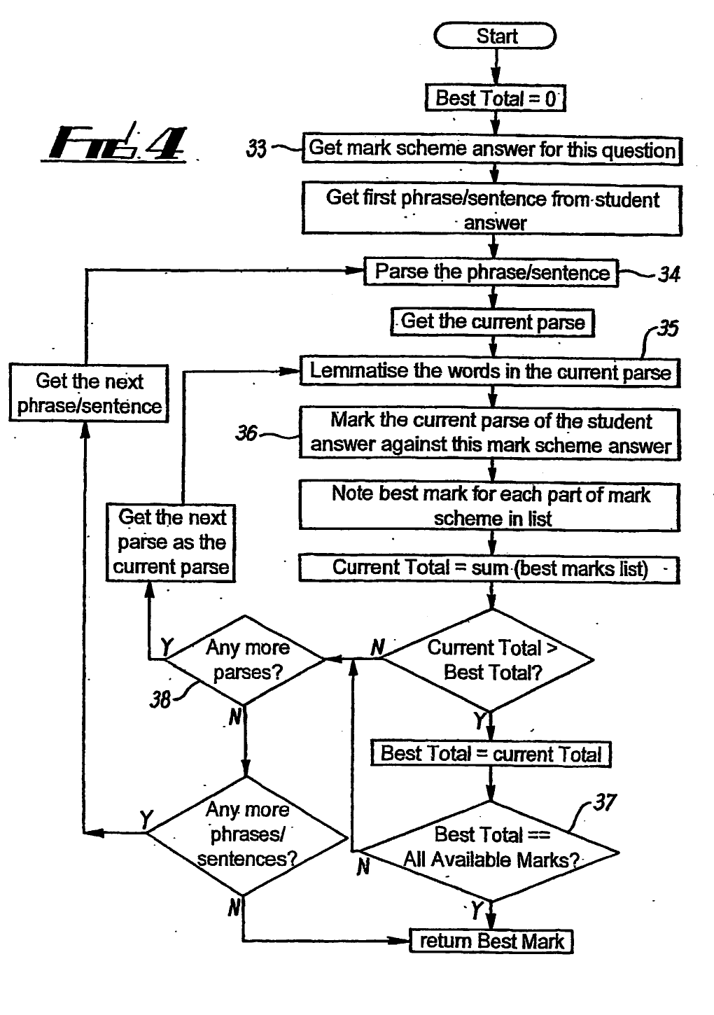

FIG. 3 illustrates the hierarchy of data structures found in the answers of the pre-defined mark scheme;

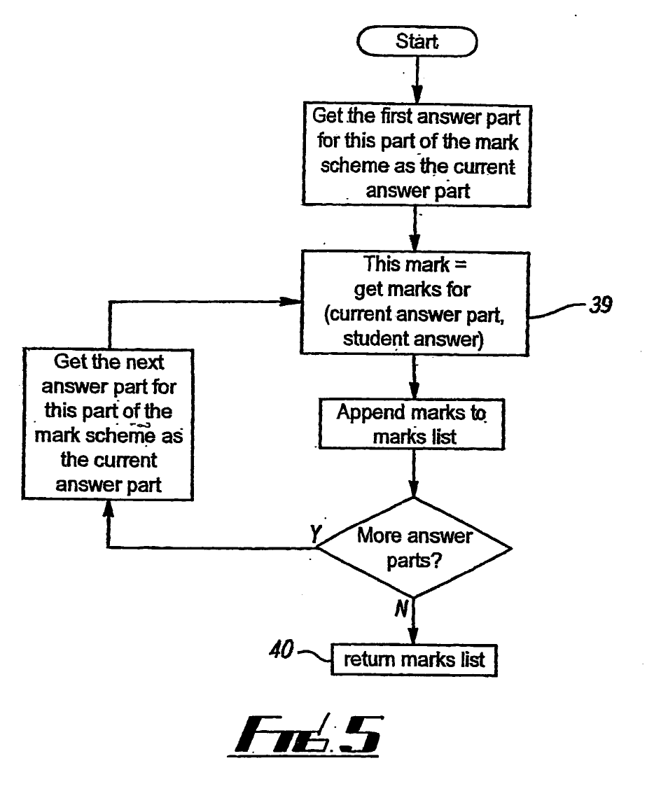

FIG. 4 illustrates the pattern-matching algorithm used to compare the student answer to the mark scheme answer;

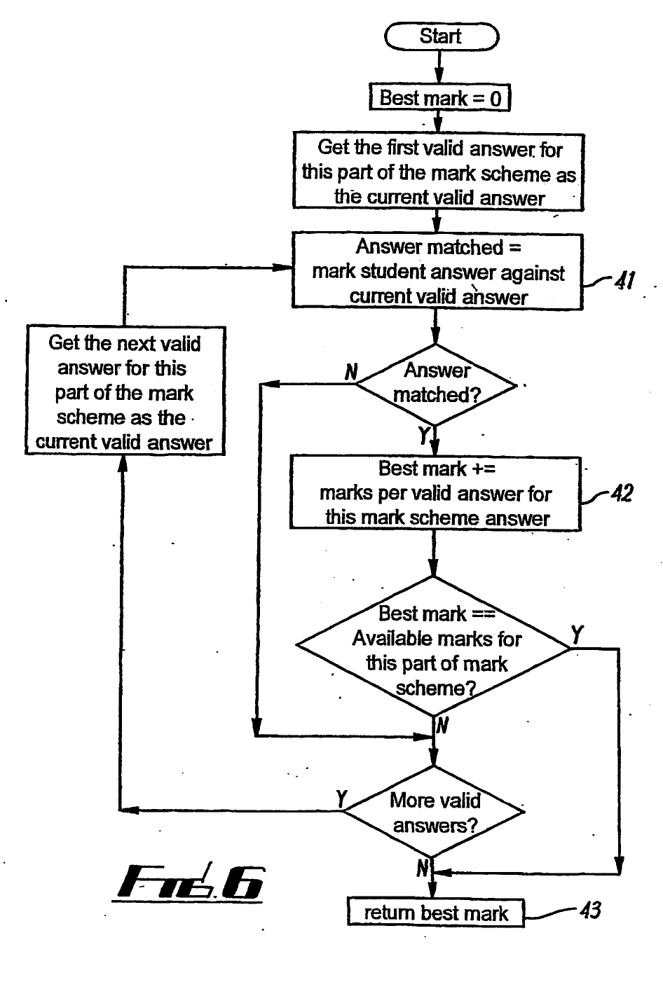

FIG. 5 illustrates the process of marking of a parse of the student answer against the mark scheme answer;

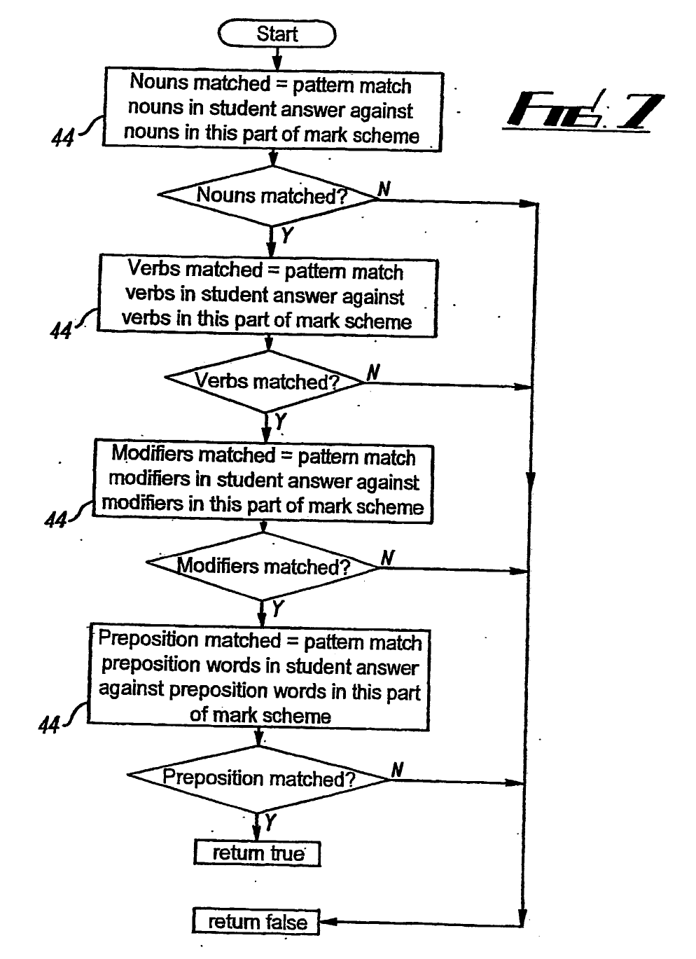

FIG. 6 illustrates the calculation of whether a mark should be awarded or not for a particular part of the mark scheme for a single parsed student answer;

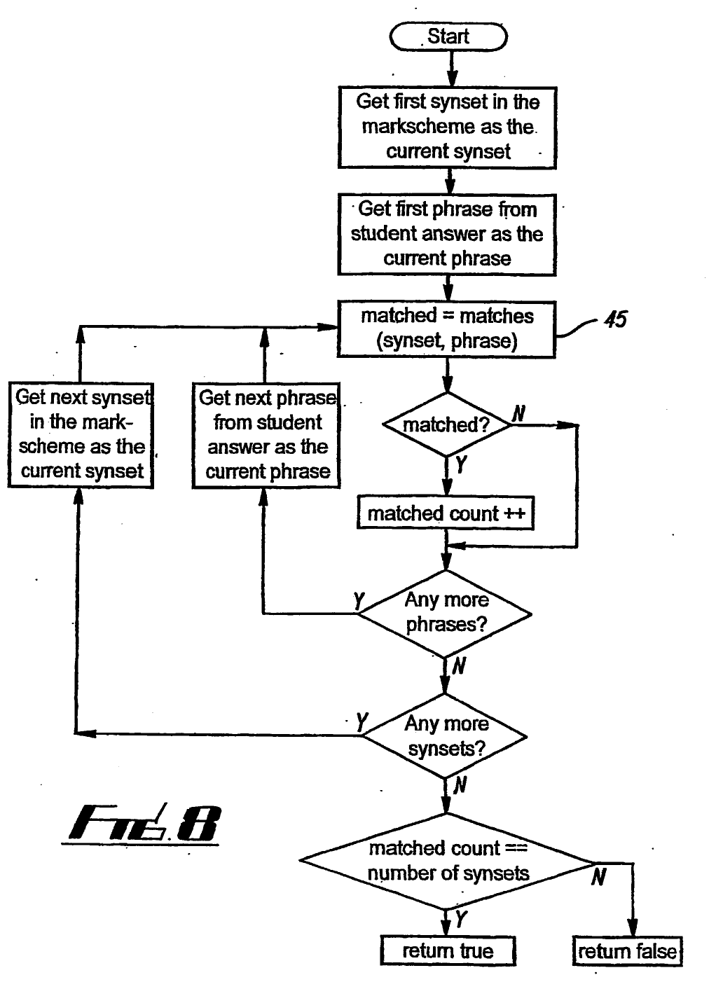

FIG. 7 illustrates the matching of a single parsed student answer against a single relevant valid pre-defined mark scheme answer;

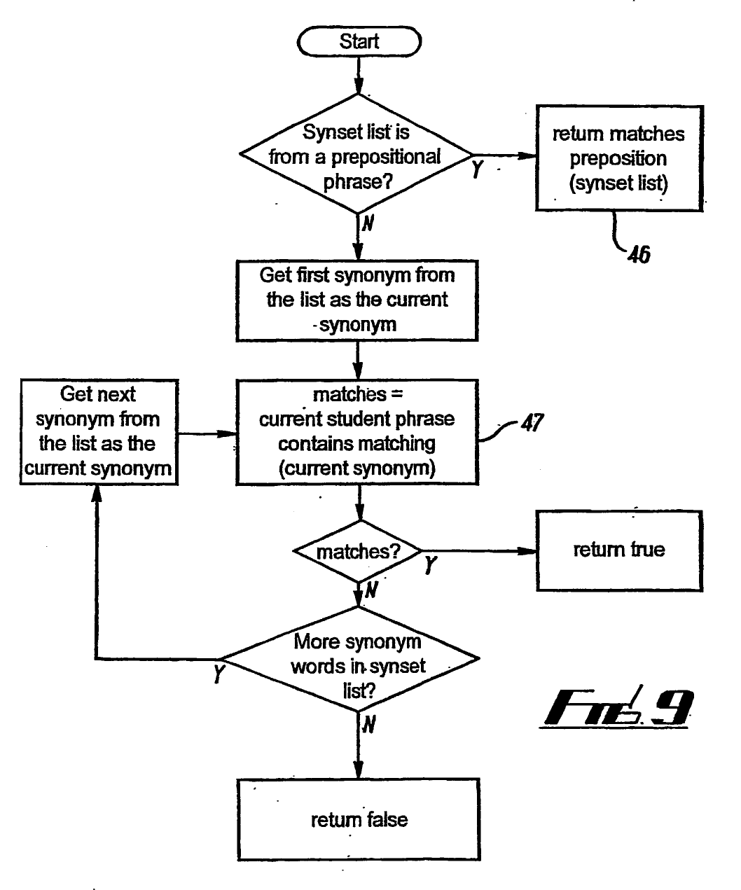

FIG. 8 illustrates the pattern-matching of nouns, verbs, modifiers or prepositions in the student answer against nouns, verbs, modifiers or prepositions in the relevant part of the pre-defined mark scheme answer;

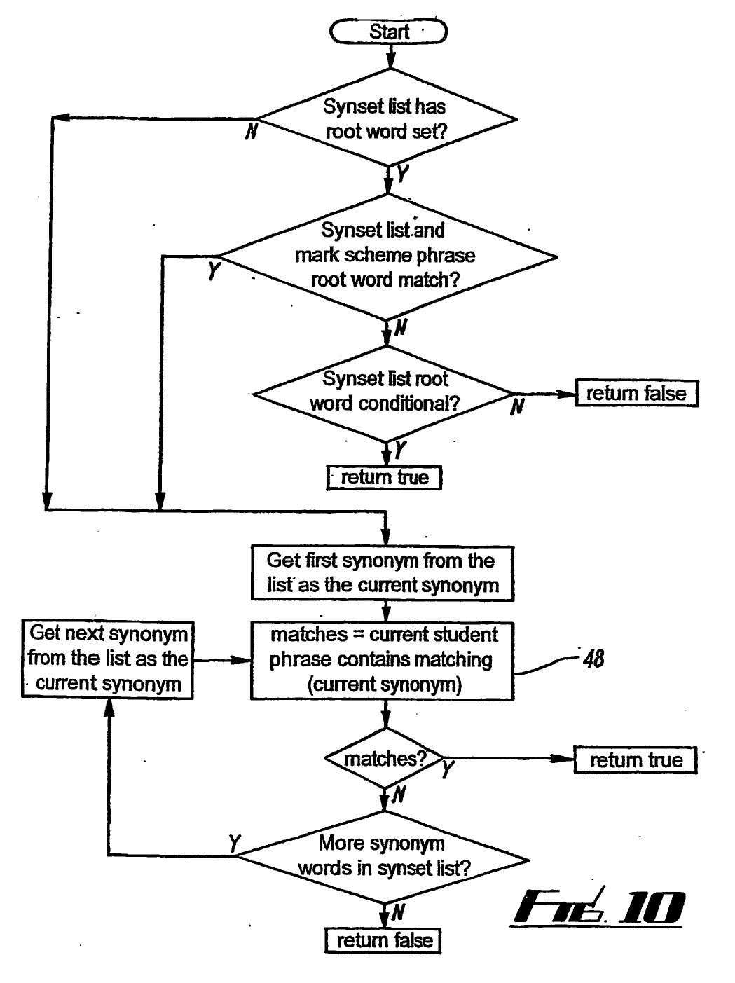

FIG. 9 illustrates the matching of one phrase in the student answer to a synset list (i.e. a list of tagged words from the mark scheme containing one or more synonym words);

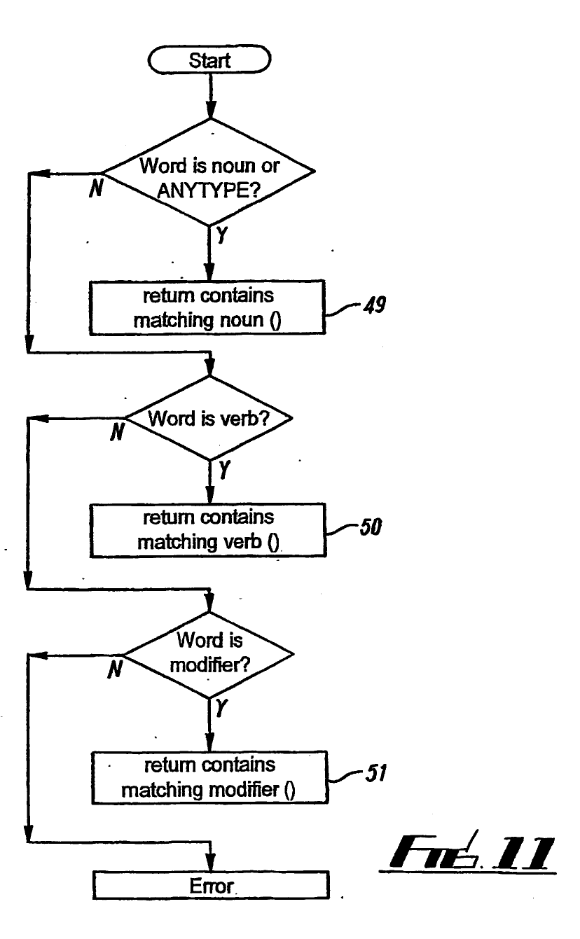

FIG. 10 illustrates the matching of a single phrase found in the preposition of the student answer against a synset list of tagged words found in the preposition of the mark scheme;

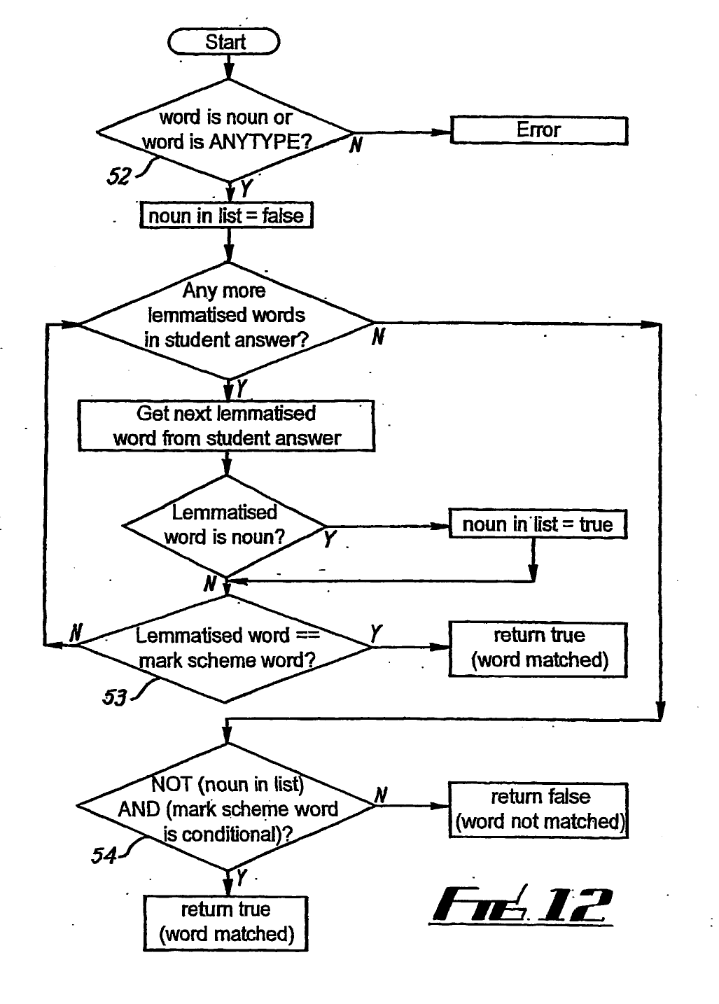

FIG. 11 illustrates the matching of each word in a single phrase found in the student answer against each single tagged word in the mark scheme, checking the type of the tagged word and calling the appropriate matching scheme;

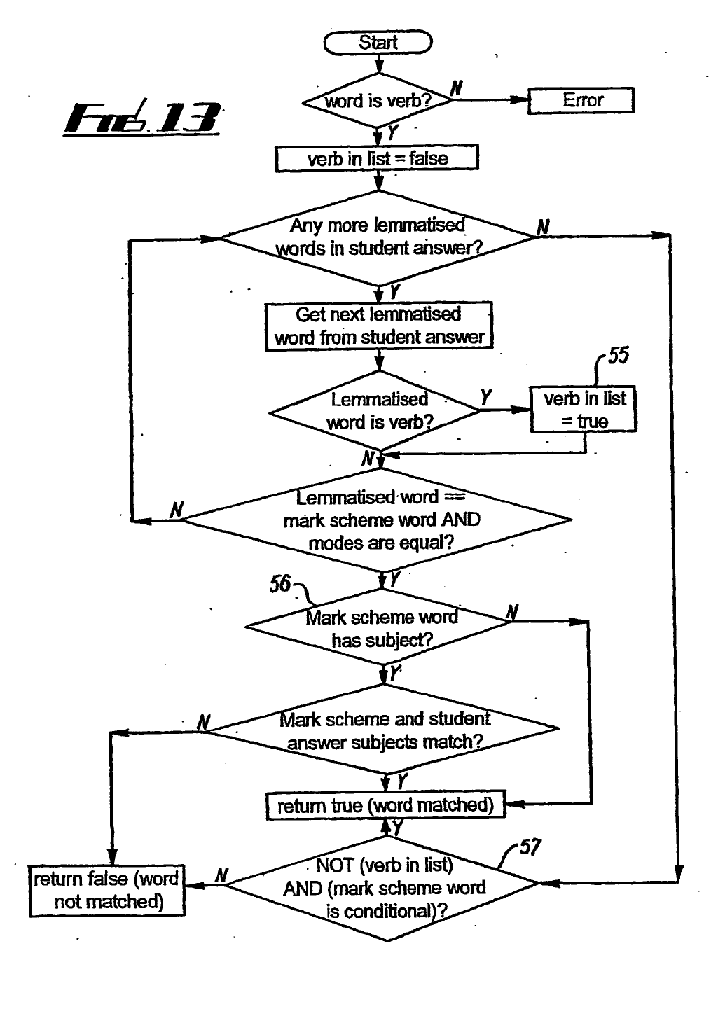

FIG. 12 illustrates the matching of each word in a single phrase found in the student answer against each single tagged word in the mark scheme, if the type of word is a noun or “ANYTYPE”;

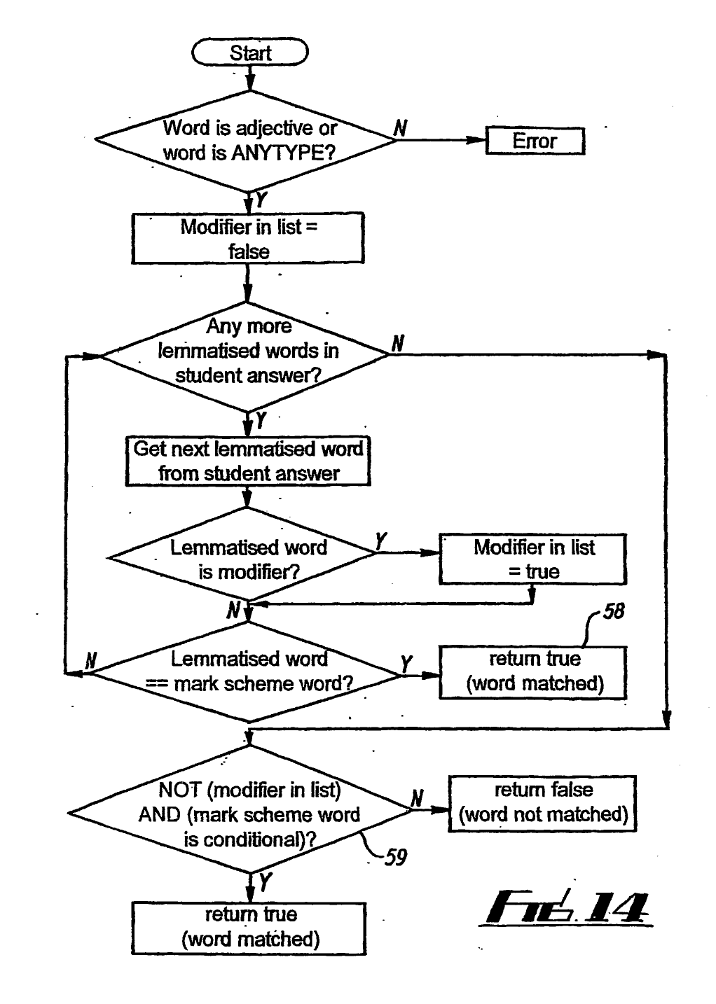

FIG. 13 illustrates the matching of words if the type of word is a verb;

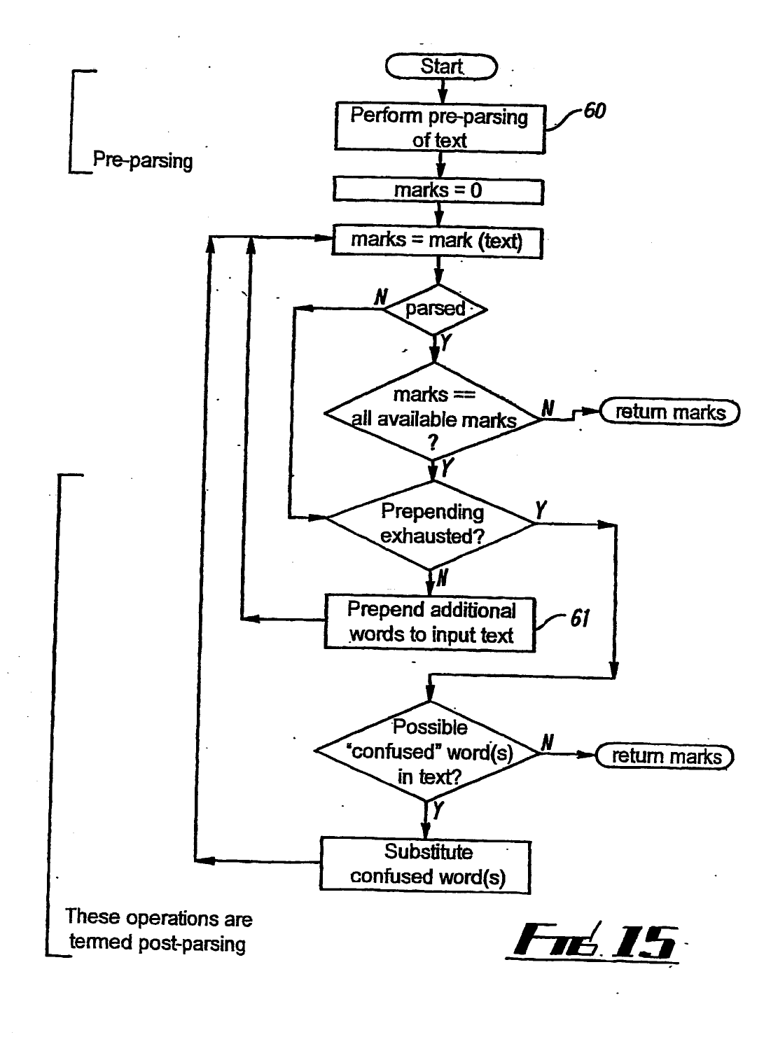

FIG. 14 illustrates the matching of words if the type of word is a modifier; and

FIG. 15 illustrates the operations of pre- and post-parse processing of free-form text to take account of commonly made errors in the text.

Although the embodiment of the invention described hereafter with reference to the drawing comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or any other form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or by other means.

When the program is embodied in a signal which may be conveyed directly or by a cable or other device or means, the carrier may be constituted by such cable or other device or means. Alternatively, the carrier may be an integrated circuit in which the program is embedded, the integrated circuit being adapted for performing, or for use in the performance of, the relevant processes.

Referring firstly to FIG. 1, a flow diagram is depicted illustrating the electronic assessment of free-form text, e.g.—student answers to examination or test questions where the answer is in a free-form text format and is assessed against a free-form text mark-scheme. Natural language processing is used to pre-process each mark-scheme answer to generate a template containing a semantic and syntactic information for that answer; this procedure is required to be carried out only once for each mark-scheme answer. Each answer submitted in the test or examination is similarly processed in natural language to syntactically and semantically tag it, and is then pattern-matched against the mark-scheme template. The extent of match with the template determines the degree to which the submitted answer is deemed to be correct, and marks or grades are allocated according to the mark scheme.

Data-sets in accordance with the free-form text mark-scheme answers are entered as a preliminary step 1 into the computer-based system. The data is operated on in a natural-language parsing process 2 which deconstructs the free-form text into constituent parts, including verbs, nouns, adjectives, adverbs, prepositions, etc. The derived data-representations of the constituent parts of each answer are submitted in step 3 to a semantic-analysis process 4.

In the semantic analysis of process 4 the syntactic structure is pruned of superfluous words, and the remaining words lemmatised (by which variant forms such as “going” and “went” are reduced to the verb “go”) and annotated with semantic information, including synonyms, mode of verbs (positive or negative), etc. Additional information relating to the structure of allowable pattern matches is introduced, so as to derive in step 5 data representative of a template against which a range of syntactically and semantically equivalent phrases can be matched. The template is representative of key syntactic elements of the mark scheme, tagged with semantic information and pattern-matching information, utilising data supplied.from a lexical database 6.

A human operator who uses natural language experience and knowledge, acts in conjunction with data from data store 8, to tailor the template appropriately for the mark-scheme answers The data in store 8 is related to a corpus or body of test data, the data being available to the operator for testing and modifying the template derived in process 5.

Student answer text 11 is pre-parse processed to give the input text an improved chance of being parsed by the natural language parser 12. The pre-parse processed answer, which may be broken into constituent parts such as sentences or phrases 9 is parsed using the natural language processing parser 12 corresponding to that of process 2. The derived data representations of the constituent parts of each answer may then submitted in step 13 to semantic tagging process 14. In this process, key words are lemmatised and additional semantic information may be attached, including e.g., modes of verbs, with the help of lexical database 6, to produce in step 15 the key syntactic structure of the answer with semantic information tagged on.

A comparison process 20 is now carried to pattern match the semantic-syntactic text of step 15 with the template of step 5. The process 20 is carried out to derive in step 22 mark-scheme matching data. This latter data specifies how many, if any, mark-scheme answers are satisfied by the answer submitted in the test or examination. A mark-allocation process 23 is performed in accordance with this result and data supplied by a database 24. The data from the database 24 specifies how many marks are to be awarded for each of the correctly-matched items of the submitted answer, and the resultant output step 25 of the process 23 accordingly provides a marking or grading of the submitted answer. If necessary, post-parse processing 21 takes place to address poor spelling and punctuation in the input text which might otherwise prevent the parser and text marking algorithm from performing to an acceptable standard. The process of steps 11-23 continues until all the marks available have been awarded, or all the parts of the original answer have been processed (including pre-parse processing 10 and post-parse processing 21) and any marks which were due have been awarded.

The processing of answers submitted in the test or examination, to produce the output marking or grading may be performed in real time online (for example, via the Internet). The procedure for the preparation of the snmantic-syntactic template, since it needs to be carried out only once, may even so be off-line.

Referring to FIG. 2, the free-form text Student Answer 11 undergoes natural language processing. The Student Answer 11 contains free-form text made up of noun phrases, verb phrases, modifier phrases and prepositional phrases. These phrases are extracted from the Student Answer 11 text and stored as Phrase Lists 26. Each Phrase 27 in the Phrase Lists 26 contains a list of Tagged Words 28, lemmatised versions of the words in this list and, optionally, the rootword if the phrase is a preposition. Each Tagged Word 28 contains the word, Its type (noun, verb, modifier or ANYTYPE), its mode (used only for verbs), its Matching Mode (ie, if it is required or conditional) and, if the word is a verb, its subject, subject type and subject matching mode.

Referring to FIG. 3, Mark Scheme 1 is parsed using natural language processing. The Mark Scheme 1 hierarchy is made up of Mark Scheme Answer 29, which in turn contains the question number's i.d. and a list of Answer Parts 30. Answer Part 30 contains a list of Answer Objects 31, each representing a valid answer according to the mark scheme 1, the total number of marks available for this particular Answer Part 30 and the number of marks awarded per match answer. Answer Object 31 contains the text of the original Mark Scheme Answer 29, plus a list of Tagged Words 32 made up of the word, its type (noun, verb, modifier or ‘anytype’), its mode used only for verbs, its ‘Matching Mode’ (i.e., if it is required or conditional) and, if the word is a verb, its subject, subject type and subject matching mode.

Referring to FIG. 4, the process of pattern-matching the student answer against the mark scheme answer is shown. This is a top level routine which is provided with the raw text of the student answer and the i.d. of the question. It first obtains the part of the mark scheme associated with that particular questions (step 33). It then, optionally, breaks up the student answer into sentences or phrases (this is optional because short or single phrase answers will not be broken up). It then gets all possible parses of each phrase or sentence (step 34). It tries each parse (after lemmatising the words contained therein, step 35) against the associated mark scheme (step 36) until all the available marks for this question have been awarded (step 37), or no more sentences/phrases are left (step 38). In the latter case, the number of marks the answer received (zero or more) are totalled and returned.

Referring to FIG. 5, step 36 of FIG. 4 is expanded upon as the current parse of the student answer is compared against the relevant mark scheme answer. This routine has access to the appropriate Mark Scheme Answer for this questions (see FIG. 3). It is passed in Phrase Lists of nouns, verbs, modifiers and prepositional phrases extracted from one parse of the student answer. This process awards a mark to the student answer for each part of the mark scheme (step 39) and returns these marks as a list (step 40).

Referring to FIG. 6, step 39 of FIG. 5 is expanded upon as it is calculated whether a mark should be awarded to a particular part of the student answer for a particular part of the mark scheme. This routine has access to one Answer Part of a Scheme Answer for this question (see FIG. 3). The routine is provided with Phrase Lists of nouns, verbs, modifiers and prepositional phrases extracted from one part of the student answer. It marks the student answer against the current valid answer of the mark scheme (step 41′). If the answers match, the “best mark” total is added to (step 42) Finally, the best mark achieved by the student answer in this Answer Part is returned (step 43).

Referring to FIG. 7, step 41 of FIG. 6 is expanded upon, as the relevant part of the student answer is compared against the relevant valid answer of the mark scheme. This routine has access to one Answer Object (see FIG. 3) which represents one valid answer according to the mark scheme. It is passed in Phrase Lists of nouns, verbs, modifiers and prepositional phrases extracted from one parse of the student answer. It then tries to match the student answer Phrase Lists against the valid answer's Answer Object (step 44), returning true if it succeeds, false if otherwise.

Referring to FIG. 8, step 44 of FIG. 7 is expanded upon as specific types of words (ie, nouns, verbs, modifiers and prepositions) are matched to the mark scheme answer. This routine has access to one Phrase List (see FIG. 2) extracted from the student answer. It is passed in a list of “synsets”, each synset being a list of Tagged Words from the mark scheme (see FIG. 3). Each list contains one or more synonym words (which may be either nouns, verbs or modifiers). The routine tries to match the words in the mark scheme against the words in this Phrase List (step 45), returning true if it succeeds and false if otherwise. For the process to return true (i.e.—match), a word in each synset list must be uniquely matched against a word in the student answer, i.e.—a word in the student answer can only match a word in one synset list. All synsets must be matched to return true.

Referring to FIG. 9, step 45 of FIG. 8 is expanded upon. This routine has access to one phrase extracted from the student answer (see FIG. 2). It is passed in a synset list of Tagged Words from the mark scheme (see FIG. 3). Each list contains one or more synonym words, which may be either nouns, verbs or modifiers. The routine tries to match the words in the synset list against the words in this phrase (step 47), returning true if it succeeds and false otherwise. If the synset list is from a prepositional phrase, it is put through a different routine (step 46) which will be detailed below.

Referring to FIG. 10, step 46 of FIG. 9 is expanded upon. This routine has access to one Phrase (see FIG. 2) extracted from the student answer. It is passed in a synset list of Tagged words (see FIG. 3) found in the preposition of the mark scheme. Each list contains one or more synonym words (which may be either nouns, verbs or modifiers). The routine tries to match the words in the synset list against the words in this Phrase, returning true if it succeeds, false if otherwise. The logic in returning true if a match is found is that if the root word is conditional then the preposition as a whole is treated as conditional. For each synonym in the synset list, the routine then tries to find a word in the student answer which matches (step 48). The matching process will depend on whether the word being matched is a noun, verb or modifier.

Referring to FIG. 11, step 48 of FIG. 10 is expanded upon. This routine has access to one Phrase extracted from the student answer. The routine is passed in a single Tagged Word found in the mark scheme (see FIG. 3). The routine checks the type of the Tagged Word and calls the appropriate matching routine (steps 49, 50 and 51).

FIG. 12 expands upon step 49 of FIG. 11 when a noun is matched, or a word of ANYTYPE. The routine has access to one Phrase extracted from the student answer (see FIG. 2). It is passed in a single Tagged Word found in the mark scheme (see FIG. 3), which should be a noun or ANYTYPE (step 52). The routine checks the words against each lemmatised word in the Phrase, returning true if a match is found. It is at this point (53) that the actual text of the mark scheme word and student answer words is compared. This is the lowest level operation in the matching algorithm.

There is also a special case, whereby if there were no nouns in the Phrase, and the mark scheme word is conditional, then this is also taken as a match (step 54).

Referring to FIG. 13, this routine has access to one phrase extracted from the student answer (see FIG. 2). It is passed in a single Tagged Word found in the mark scheme (see FIG. 3), which should be a verb. The routine check the word against each lemmatised word in the Phrase, returning true if a match is found (55) This may optionally, include checking that the subject matches, depending on whether the mark scheme word has the subject set or not (56). There is also a special case whereby if there are no verbs in the Phrase and the mark scheme words is conditional, then this is also taken as a match (57).

Referring to FIG. 14, this routine has access to one Phrase extracted from the student answer (see FIG. 2). It is passed in a single Tagged Word found in the mark scheme (see FIG. 3), which should be a modifier. The routine checks the word against each word in the Phrase, returning true if a match is found (53). There is also a special case, whereby if there were no modifiers in the Phrase, and the mark scheme word is conditional, then this is also taken as a match (59).

Referring to FIG. 15, the process of pre- and post-parse processing is shown. Pre-parse processing at point 60 prepares the free-form text to give it the best chance of being effectively parsed by the parser. Any additional words prepended to the answer during preparsing are removed from the parse before marking.

Errors of poor spelling, punctuation or grammar will often lead to a failure to parse, or a parse which does not properly reflect the meaning of the input text. Pre-parse processing attempts to reduce or eliminate such problems. Pre-parse processing proceeds through two stages: Character Level pre-parse processing and Word Level pre-parse processing.

1. Character level pre-parse processing involves processing each input string in turn, applying rules to carry out such effects as converting the text to full sentences and eliminating punctuation errors.

Word level pre-parse processing involves processing each word of the input string in turn, applying the following rules (provided by way of example and not limited to the following):

1. Spell check each word, as described below.

2. Replace words with more than 30 characters with the text “longword”. Such words cannot be valid input, and can cause problems with some parsers.

3. Substitute recognised concatenations of words by expanded equivalents,

e.g. replace “aren't” by “are not” replace “isn't” by “is not”, replace “shouldn't” by “should not”, replace “they've” by “they have” etc.

At this stage, a spell checking algorithm is applied in conjunction with spell checking software, and the following rules are applied to each word to be spell checked:

1. If the word is recognised by the spell checking software, return the original word (i.e. it is spelled correctly).

2. If it is recognised, obtain a list of suggestions from the spell checking software.

3. If there are no suggest-ions from the spell checking software, return the original word.

4. Loop through each suggested word applying the following rules.

a. If the current suggested word is in the mark scheme associated with the current question, return the current suggestion as the new word.

b. If not, lemmatise the current suggested word.

c. If the lemmatised version of the current suggested word is in the mark scheme associated with the current question, return the lemmatised version of the current suggestion as the new word.

d. If not, get the next suggested word.

5. If none of the suggested words, lemmatised or otherwise, were in the mark scheme, return the first suggested word in the list (which the spell checking software has deemed is the most likely).

Pre-parse processing addresses poor spelling and punctuation in the input text which might otherwise prevent the parser and text marking algorithm from performing to an acceptable standard. There are, however, other attributes of student answers which can result in marks being withheld by the system where they might otherwise have been awarded. Thus, the process of post-parse processing addresses sentences which, although clear in meaning to a human marker, may not parse when processed by the system (even after pre-parse processing) and sentences containing semantic or grammatical errors which result in parses which will not match the mark scheme.

The electronic assessment system may be used in the following ways, which are provided by way of example only to aid understanding of its operation and are not intended to limit the future operation of the system to the specific embodiments herein described. Each of the three worked examples shows a different student answer being marked against the same part of a mark scheme.

The following text is part of a science examination question:

“John dropped a glass bottle of blue copper sulphate crystals. The bottle broke and glass was mixed with the crystals.

a) suggest how John or a teacher could clear up the mixture safely, without cutting themselves.

1 mark”

The mark scheme answer associated with this part of the question is as follows.

a) pick it up with.a dustpan and brush

accept ‘sweep it up’ or ‘hoover it up’ or

‘use a vacuum cleaner’.

accept ‘wear gloves’ or ‘use tweezers’.

So, for the system to operate, the system needs to be set up to accept versions of all the valid answers specified in the mark scheme (plus others which are equivalent). However in the following worked examples, we use just the one valid mark scheme answer: “sweep it up”. The examples will show how the following student answers are marked, thus:

“The teacher could have swept up the glass” gets 1 mark, which is correct.

“Sweep up” gets 1 mark, which is correct.

“Sweep up the carpet” gets 0 marks, which is correct.

The mark scheme has been set up to match student answers which contain a verb which is a synonym of “sweep”, with a prepositional phrase which contains the word “up” and, conditionally, a synonym of “mixture”. Note that strictly speaking not all the words are synonyms of “mixture”, but they are acceptable equivalents in the context of this mark scheme answer. The use of conditional words in the preposition is to enable the mark scheme answer to successfully match “sweep up” but not match “sweep up the carpet”.

The Mark Scheme Developed for “Sweep it up”

No noun phrase words specified.

Verb Phrase Words:

Synset 1:

broom (mode=affirmative)

sweep (mode=affirmative)

brush (mode=affirmative)

hoover (mode=affirmative)

No modifier phrase words specified.

Prepositional Phrase Words:

Synset 1:

up (ANYTYPE, matching=required)

Synset 2:

mix (noun, matching=conditional)

mixture (noun, matching=conditional)

it (noun, matching=conditional)

glass (noun, matching=conditional)

bit (noun, matching=conditional)

mess (noun, matching=conditional)

Note that:

a) The type of a word can be either noun, verb, modifier, or ANYTYPE. Only words of the same type can be matched with each other, but a word of ANYTYPE can match with a word of any type.

b) The mode in the verbs can be either affirmative or negative:

i. “the-dog runs” the verb “run” is affirmative.

ii. “the dog will not run” the verb “run” is negative.

A synset is a list of synonyms. If the mark scheme specifies more than one synset for a particular syntactic class (as is the case in the preposition above), then each synset must be matched. There is a possible exception to this if the words in a synset are conditional, again this may be better understood when working through the examples.

Take as an example the student answer

“The teacher could have swept up the glass”.

The student answer is parsed (see FIG. 4). In this case there is only one possible parse, which returns the following Phrases.

Noun Phrases

Phrase 0: the glass (noun)

Phrase 1: the teacher (noun)

Verb Phrases

Phrase 0: could (verb, mode=affirmative, subject=teacher) have (verb, mode=affirmative) swept (verb, mode=affirmative) up the glass (noun)

Modifier Phrases

Phrase 0: up

Phrase 1: the

Phrase 2: the

Prepositional Phrases

Phrase 0: (root=have): swept (verb, mode=affirmative)

up the glass (noun)

Phrase 1: (root=swept): up the glass (noun)

The student answer parse is now lemmatised. In this case, the only change is that “swept” becomes “sweep”.

Noun Phrases

Phrase 0: the glass (noun),

Phrase 1: the teacher (noun),

Verb Phrases

Phrase 0: could (verb, mode=affirmative, subject=teacher) have (verb, mode=affirmative) sweep (verb, mode=affirmative) up the glass (noun)

Modifier Phrases

Phrase 0: up

Phrase 1: the

Phrase 2: the

Prepositional Phrases

Phrase 0: (root=have): sweep (verb, mode=affirmative) up the glass (noun)

Phrase 1: (root=sweep): up the glass (noun)

Matching of student answer against mark scheme is now described.

This is a relatively straightforward example. There is only one part to this mark scheme answer, and there is one mark available. The marking process therefore comes down to matching the Phrases in the student answer against the AnswerObject set up for “sweep it up”, as shown at a high level in FIG. 7. In English, the matching process for this example is summarised as follows.

Step 1: Noun Matching

No nouns in mark scheme, so no noun matching required to satisfy mark scheme answer.

Step 2: Verb Matching

Verb matching searches through each verb phrase of the student answer in turn looking for words which can be matched against the verbs specified in the mark scheme

The mark scheme has one synset of verb phrase words. These are:

broom (mode=affirmative)

sweep (mode=affirmative)

brush (mode=affirmative)

hoover (mode=affirmative)

The student answer has one phrase which contains the following verbs:

could (verb, mode=affirmative, subject=teacher)

have (verb, mode=affirmative)

sweep (verb, mode=affirmative)

The verbs “could” and “have” are not matched, but the verb sweep is matched, since it is the same verb with the same mode. If the mark scheme had specified that the verb also had a subject, then the verb in the student answer would have needed the same subject in order to match The mark scheme is therefore satisfied with respect to verbs.

Step 3: Modifier Matching

No modifiers in mark scheme, so no modifier matching required to satisfy mark scheme answer.

Step 4: Preposition Matching

The mark scheme has two synsets of prepositional phrase words. These are:

up (ANYTYPE, matching=required) and

mix (noun, matching=conditional)

mixture (noun, matching=conditional)

it (noun, matching=conditional)

glass (noun, matching=conditional)

bit (noun, matching=conditional)

mess (noun, matching=conditional)

For the prepositional phrase of the mark scheme to be matched, each synset therein must be matched.

The student answer has two prepositional phrases

Phrase 0: (root=have): sweep (verb, mode=affirmative) up the glass (noun)

Phrase 1: (root=sweep) up the glass (noun)

Each phrase in turn will be matched against the mark scheme. The mark scheme preposition does not have the root word set, so the root words specified in the student answer prepositional phrases are ignored. The first prepositional phrase of the student answer is successfully matched against the mark scheme answer, the word “up” is matched and the word “glass” is matched. The preposition is therefore matched against the mark scheme, which means that all parts of the mark scheme have been successfully matched, so the answer “The teacher could have swept up the glass” matches the mark scheme, and will be awarded the number of marks specified in the mark scheme.

In the second example, the student answer is “sweep up”.

The student answer is parsed (see FIG. 4). In this case there is only one possible parse, which returns the following Phrases:

No Noun Phrases

Verb Phrases

Phrase 0: sweep (verb, mode=affirmative) up

Modifier Phrases

Phrase 0: up

Prepositional Phrases

Phrase 0: (root=sweep): up

In this case, lemmatisation doesn't change any of the words.

The student answer is then matched against the mark scheme. This is a relatively straightforward example. There is only one part to this mark scheme answer, and there is one mark available. The marking process therefore comes down to matching the Phrases in the student answer against the AnswerObject set up for “sweep it up”, as shown at a high level in FIG. 7. In English, the matching process for this example is summarised as follows.

Step 1: Noun Matching

No nouns in mark scheme, so no noun matching required to satisfy mark scheme answer.

Step 2: Verb Matching

Verb matching searches through each verb phrase of the student answer in turn looking for words which can be matched against the verbs specified in the mark scheme

The mark scheme has one synset of verb phrase words. These are:

broom (mode=affirmative)

sweep (mode=affirmative)

brush (mode=affirmative)

hoover (mode=affirmative)

The student answer has one phrase which contains the following verb:

sweep (verb, mode=affirmative)

The verb sweep is matched, since it is the same verb with the same mode. The mark scheme is therefore satisfied with respect to verbs.

Step 3: Modifier Matching

No modifiers in mark scheme, so no modifier matching required to satisfy mark scheme answer.

Step 4: Preposition Matching

The mark scheme has two synsets of prepositional phrase words These are:

up (ANYTYPE, matching=required) and

mix (noun, matching=conditional)

mixture (noun, matching=conditional)

it (noun, matching=conditional)

glass (noun, matching=conditional)

bit (noun, matching=conditional)

mess (noun, matching=conditional)

For the prepositional phrase of the mark scheme to be matched, each synset therein must be matched.

The student answer has one prepositional phrase

Phrase 0: (root=sweep): up

The mark scheme preposition does not have the root word set, so the root words specified in the student answer prepositional phrases are ignored.

The word “up” in the mark scheme preposition is matched in the student answer. None of the other words in the mark scheme preposition (“mix”, “mixture”, “it”, “glass”, “bit”) are found in the mark scheme. However, because these words have matching specified as conditional, then this represents a special case. Conditional words in the preposition of the mark scheme need only be found in the student answer preposition if there is at least one word of the same type as the conditional mark scheme word found in the student answer preposition. In this case there are no nouns in the prepositional phrases of the student answer, and so the conditional words in the mark scheme preposition need not be matched.

The preposition is therefore matched against the mark scheme, which means that all parts of the mark scheme have been successfully matched, so the answer “sweep up” matches the mark scheme, and will be awarded the number of marks specified in the mark scheme.

In the third example, the student answer is “Sweep up the carpet”.

The student answer is parsed (see FIG. 4). There are two parses this time. The first parse is

Noun Phrases

Phrase 0: the carpet (noun)

Verb Phrases

Phrase 0: sweep (verb, mode=affirmative) the carpet (noun) up

Modifier Phrases

Phrase 0: up

Phrase 1: the

Prepositional Phrases

Phrase 0: (root=sweep): the carpet (noun) up

In this case, lemmatisation doesn't change any of the words.

The student answer is then matched against the mark scheme. This is a relatively straightforward example. There is only one part to this mark scheme answer, and there is one mark available. The marking process therefore comes down to matching the Phrases in the student answer against the AnswerObject set up for “sweep it up”, as shown at a high level in FIG. 7. In English, the matching process for this example is summarised as follows.

Step 1: Noun Matching

No nouns in mark scheme, so no noun matching required to satisfy mark scheme answer.

Step 2: Verb Matching

Verb matching searches through each verb phrase of the student answer in turn looking for words which can be matched against the verbs specified in the mark scheme

The mark scheme has one synset of verb phrase words. These are:

broom (mode=affirmative)

sweep (mode=affirmative)

brush (mode=affirmative)

hoover (mode=affirmative)

The student answer has one phrase which contains the following verb:

sweep (verb, mode=affirmative)

The verb ‘sweep’ is matched, since it is the same verb with the same mode. The mark scheme is therefore satisfied with respect to verbs.

Step 3: Modifier Matching

No modifiers in mark scheme, so no modifier matching required to satisfy mark scheme answer.

Step 4: Preposition Matching

The mark scheme has two synsets of prepositional phrase words. These are:

up (ANYTYPE, matching=required) and

mix (noun, matching=conditional)

mixture (noun, matching=conditional)

it (noun, matching=conditional)

glass (noun, matching=conditional)

bit (noun, matching=conditional)

mess (noun, matching=conditional)

For the prepositional phrase of the mark scheme to be matched, each synset therein must be matched.

The student answer has one prepositional phrase

Phrase 0: (root=sweep): the carpet (noun) up

The mark scheme preposition does not have the root word set, so the root words specified in the student answer prepositional phrases are ignored.

The word “up” in the mark scheme preposition is matched in the student answer. None of the other words in the mark scheme preposition are found in the mark scheme. Since there is a noun (carpet) in the preposition of the student answer, then the conditional nouns (“mix”, “mixture”, “it”, “glass”, “bit”) in the mark scheme preposition must be matched. Since there are no words in the student answer to match any of these words, then the mark scheme is not matched.

In this case there is another parse of the student answer. Steps 1 through 4 will therefore be repeated with the next parse. In this case, the second parse also fails to match the mark scheme answer. The answer “sweep up the carpet” does not match the mark scheme, and so no marks will be awarded for this part of the mark scheme.

It must be noted that these examples do not show matching where nouns or modifiers are specified in the mark scheme. The extension to these cases is straightforward. If one or more modifier synsets are specified in the mark scheme then they must be matched in the student answer. The same is true for nouns. Modifiers and nouns cannot be conditional unless they appear in the prepositional phrase of the mark scheme. Modifiers and nouns have no subject or mode.

The following is an example of each of the character level pre-parse processing operations.

Input Text:

pre-parse processing . . . this, is a test . . . one & two/three+four is <five but> zero/0.5+++I know 2===2

After character level pre-parse processing pre-parse processing this, is a test one and two or three and four is less than five but greater than zero or 0.5 and I know 2 equals 2

The following examples demonstrates the word level pre-parse processing operations.

Input Text:

there isnt a dustpin

After word level pre-parse processing:

there is not a dustbin

This example replaces the word “isnt” with “is not” and the misspelled word “dustpin” with “dustbin”. If, however the mark scheme for this question contained the word “dustpan” then the output would have been as follows.

After word level pre-parse processing:

there is not a dustpan

This demonstrates the use of context information, i.e. the misspelled word was similar to the mark scheme word “dustpan”, and so it, rather that “dustbin” was returned as the spell checked word. This is an example where contextual spell checking can result in a mark being awarded for a student answer which, using simple spell checking, would have been marked as being wrong.

Please note that replacing concatenated words (e.g. “isnt” by “is not”) is done to aid in parsing. The spell checking algorithm of the word level pre-parse processing also helps in parsing, since words which the parser does not recognise may cause a parse failure or a mis-parse. However the use of context information in spell checking will not have a significant affect on the ability to parse. Where it may have an affect is in improving the performance of the subsequent marking algorithm, since the student will have been given the benefit of the doubt in terms of interpreting a misspelled word as one of the words that contributes towards a correct answer. Again, this is inline with the way teachers mark student answers.

There is now provided two examples of post-parse processing in operation. The first example relates to a problem of sentences which, although clear in meaning to a teacher, may not parse even after the pre-parse processing operations have been carried out. The answer “sweeping it up” will not parse using our current parser (different parsers will have difficulty with different input texts, but all will fail in certain circumstance). It has been found that, for the current parser, the majority of sentences which fail to parse can be made to parse by prepending them with the words “it is”. For the current example, this gives “it is sweeping it up”. This sentence will parse quite happily, and results in the major syntactic constituents being correctly recognised. The parser will identify the verb “sweep”, with the preposition “it up”. It will also however identify the verb “is” and the noun “it”, which were introduced to aid the parse. Post processing of the parse is therefore required to remove the words “it” and “is” from all lists (verbs, nouns, modifiers, prepositions). In this way parsing of an “unparsable” sentence is achieved without introducing any words in the resultant parse which were not in the original text.

Generally, we may prepend a number of word patterns to aid parsing, and may also substitute word patterns which cause known parsing problems, in order to overcome deficiencies in natural language processing parsers.

The second example relates to a problem of sentences where the student has made a semantic or grammatical error or errors These errors may be recognised and overlooked by a teacher, however such errors will very probably result in parses which will not match with the mark scheme.

The student answer “it is there dog” will parse using the current parser, but because the student has used the word “there” instead of the word “their”, the parse does not accurately reflect the intended meaning of the sentence. Other words commonly confused by students in their answers include “wear” and “where”, and “to” and “to”.

In fact the word “dog” is omitted from the parse altogether, and the answer is interpreted by the parser as “it is there”. This is not an accurate reflection of the intended meaning of the student. A teacher in an analytical subject such as Science will overlook the grammatical error, and award a mark (assuming “it is their dog” would have been a correct answer).

Problems of semantic or grammatical errors can be addressed by substituting commonly confused words, in this case by replacing the word “their” by the word “there” and re-parsing.

An advantage of the present invention is that there is provided an interactive assessment tool which allows students answer questions in sentence form and have their answers marked online in real time. This provides the student with instant feedback on their success or otherwise.

It is a further advantage of the present invention that the marking software provides a facility for looking for evidence of understanding in submitted answers, without penalising the student unduly for common errors of punctuation, spelling, grammar and semantics. Credit is given for equivalent answers which may otherwise have been marked as incorrect.

The current system provide custom pre- and post-parse processing techniques to be applied to the free-form text answers. These, in conjunction with natural language processing tools, utilise several novel natural language processing algorithms.

The pre-parse processing module standardises the input text to enable the parsing process to perform successfully where an unprocessed answer would otherwise be discounted if processed by other natural language processing systems and conventional information extraction systems. The custom developed post-parse processing module corrects common errors in text answers which might otherwise result in incorrect marking, as the answer is clear in meaning but contain errors, i.e.—the system does not penalise students for poor English if their understanding of the subject is clearly adequate. Pre- and post-parse processing techniques seen in the current invention provide the same level of robustness in marking imperfect or incomplete answers.

The utilisation of a novel representation of the syntactic and semantic constituents parsed text provides the advantage of enabling the construction of a single mark scheme template which can map to hundreds (sometimes thousands) of variations in the input text.

The system also features a novel semantic pattern-matching algorithm used to apply the mark scheme templates to the parsed input text.

Further modifications and improvements may be added without departing from the scope of the invention herein described.

1. A method for the computer based assessment of a submitted free-form text against a standard for such text, the method including the steps of information extraction.

2. A method as claimed in claim 1 wherein the steps of information extraction include the steps of:
a) Preparing a semantic syntactic template from the standard text;
b) Preparing a semantically syntactically tagged form of the submitted text;
c) Comparing the template with the tagged submitted text; and
d) Deriving an output assessment in accordance with the comparison.

3. A method as claimed in claim 2 wherein steps (a) and (b) include the step of natural language processing.

4. A method according to claim 3 wherein the step of natural language processing includes the step of parsing the text into constituent parts.

5. A method according to claim 4 wherein the step of natural language processing further includes the step of lemmatising the constituent parts.

6. A method according to claim 3 or claim 4 wherein the step of natural language processing includes the step of tagging the constituent parts with semantic information.

7. A method as claimed in claim 6 wherein the step of tagging includes the step of accessing a lexical database.

8. A method as claimed in claim 2 wherein before step (c) there is included a further step of modifying the template using additional data.

9. A method as claimed in any one of the claims 2 to 8 wherein step (c) includes the step of pattern matching key syntactic structures of the template and the tagged submitted text.

10. A method as claimed in any preceding claim wherein the method further includes the step of processing the submitted text in a contextual spellchecker.

11. A method as claimed in any one of the claims 3 to 10 wherein the method further includes the step of pre-parse processing the submitted text prior to natural language processing.

12. A method as claimed in any one of the claims 3 to 11 wherein the method further includes the step of post-parse processing the submitted text prior to natural language processing.

13. A system for computer based assessment of a submitted free-form text against a standard for such text, the system comprising means to perform the method of any one of the claims 1 to 12.

14. A computer program comprising program instructions for causing a computer to perform the process of computer-based assessment of free-form text against a standard for such text, the method comprising steps of any one of claims 1 to 12.

15. A computer program comprising program instructions which, when loaded into a computer, constitute the processing means for computer-based assessment of free-form text against a standard for such text, the system comprising means to perform the method of any one of claims 1 to 12.

16. A method for computer-based marking of an examination script including the method of any one of claims 1 to 12 wherein the submitted free-form text is at least one answer to at least one question of the examination script from at least one examination candidate, the template is representative of mark scheme answers to the questions of the examination script and the output assessment is a grading of the candidates answers to the examination script.

17. A method as claimed in any one of claims 1 to 12, 14 or 16 wherein the method is performed in real time.

18. A method as claimed in any one of claims 1 to 12, 14, 16 or 17 wherein the method is performed over the Internet.
